(19) United States
(12) Patent Application Publication
(10) Pub. No.: US 2006/0241524 A1
(43) Pub. Date: Oct. 26, 2006

(54) Intravascular ultrasound catheter device and method for ablating atheroma

(75) Inventors: Yee-Chun Lee, Mountain View, CA (US); Shiu-Shin Chio, Rancho Santa Fe, CA (US); Qi Yu, City of Industry, CA (US)

Correspondence Address: CHEIN-HWA S. TSAO, 6684 MT PAKRON DRIVE, SAN JOSE, CA, 95120, US

(73) Assignee: Qi Yu, City of Industry, CA (US)

(21) Appl. No.: 11/134,983

(22) Filed: May 23, 2005

Related U.S. Application Data
(63) Continuation-in-part of application No. 11/077,942, filed on Mar. 11, 2005.

(51) Int. Cl. A61H 1/00

(52) U.S. Cl. 601/2; 600/1

(57) ABSTRACT

An intravascular catheter device having a catheter and an ultrasound ablation manifold is proposed for generating cavitations and acoustic jet streams in the blood to ablate atheroma. The ablation manifold has a power transducer and a coupled leaky acoustic cavity. The leaky acoustic cavity contains a first portion of ultrasonic power emission for intra-cavity ablation while allowing a second portion of ultrasonic power emission to leak outside for an extra-cavity ablation. The power transducer and the leaky acoustic cavity are configured to form a confocal resonant cavity. An intervening bird cage is coupled to the resonant cavity for stronger resonance while maintaining ultrasound leakage. A protective shield is mounted around the waist of bird cage to strengthen resonance and to prevent damaging the intima from an otherwise normal incidence of high intensity ultrasound. A microbubble releasing device and micro pump are also included to further increase the ablation efficacy.

### CROSS REFERENCE TO RELATED APPLICATION

This application is a continuation-in-part of U.S. patent application Ser. No. 11/077,942, filed Mar. 11, 2005, which is incorporated herein by reference in its entirety and for all purposes.

### BACKGROUND OF THE INVENTION

1. Field of the Invention

The present invention relates generally to the field of medical apparatus. More particularly, this invention relates to an intravascular ultrasound catheter device for ablating undesirable deposits from an inner blood vessel wall.

2. Description of the Related Art

See corresponding section from U.S. patent application Ser. No. 11/077,942.

### SUMMARY OF THE INVENTION

An intravascular ultrasound catheter device is proposed for ablating undesirable blood vessel deposits. The apparatus includes a recirculating blood delivering and injecting unit and a blood extracting and pressurizing unit for delivering and forcefully injecting pressurized source blood into a blood vessel under treatment and, after the ablation, for recirculating the injected blood back for redelivery and reinjection.

The recirculating blood delivering and injecting unit can also administer drugs designed for treating a localized diseased area under ablation but otherwise may be undesirable if dispersed elsewhere in the body. The recirculating blood delivering and injecting unit functions to automatically collect and recycle the drugs for an optional re-injection.

The recirculating blood delivering and injecting unit includes a series connection of a dual tube in communicative connection with the blood extracting and pressurizing unit, a secondary manifold and an injector nozzle. The series connection effects the forceful ejection of the pressurized source blood into the blood vessel under treatment and also effects the recirculation of a part of the injected blood back for redelivery and reinjection. Additionally, the series connection further realizes the benefit of single point invasion into the patient's body thus reduces the risk and discomfort associated with an otherwise multiple point invasions.

The blood extracting and pressurizing unit further includes a primary manifold having a primary inlet, a primary outlet and a pumping device connected in between for receiving the source blood from the dual tube and pressurizing the source blood for delivery to the dual tube.

The dual tube has a delivery tube and a return tube. The delivery tube has an upstream delivery end and a downstream delivery end. The upstream delivery end is connected to the primary outlet and the downstream delivery end is connected to the secondary manifold. The return tube has an upstream return end and a downstream return end. The upstream return end is located downstream of and connected to the injector nozzle. The downstream return end is connected to the primary inlet.

The secondary manifold has a reception and confinement unit located upstream of and connected to the return tube via its upstream return end. The reception and confinement unit further includes a deflector head located downstream of the injector nozzle for deflecting and returning part of the ejected source blood into the upstream return end for redelivery and reinjection.

For those cases where the recirculating blood delivering and injecting unit further includes an RF discharging tip near the injector nozzle, the deflector head is made electrically conductive effecting an efficient focusing and concentration of the emitted RF power from the RF discharging tip.

For those cases where the recirculating blood delivering and injecting unit further includes an electrical discharge device near the injector nozzle, the reception and confinement unit is also made electrically conductive allowing a bipolar discharge mode to neutralize, with higher efficiency compared to an otherwise unipolar discharge mode, excess opposite-sign charges generated from the tearing of healthy or diseased tissues during the ablating process.

The secondary manifold further includes a power transducer, affixed in proximity to the injector nozzle tip, for converting a high frequency power electrical signal of one or more frequencies into an ultrasonic power emission into the blood to remove the undesirable deposits via pulverization and emulsification.

The primary manifold also includes an inline filter for ridding the extracted recirculated blood of ablated plaques and calcification debris before redelivery and reinjection.

The reception and confinement unit can be further shaped and sized to form, together with the injector nozzle, an ultrasonic acoustic cavity to reflect and confine the ultrasonic power emission thus correspondingly increases the confined ultrasound energy density and the ablating power. This also limits a potentially negative biological effect of the high power ultrasonic emission on otherwise healthy tissues located away from the diseased region under treatment.

An intravascular ultrasound catheter device for the generation of cavitations and concomitant high-speed acoustic jet streams in the blood to pulverize, emulsify thus ablate atheroma. The ultrasound catheter device has an elongated catheter tube and a terminal ultrasound ablation manifold. The elongated catheter tube works to pierce a blood vessel under treatment and to reach an atheromatous area. The ultrasound ablation manifold is mounted near the distal tip of the catheter tube for ultrasonically ablating atheroma from the atheromatous area.

The ultrasound ablation manifold has a power transducing device and a leaky acoustic cavity. The power transducing device converts a high frequency power electrical signal of one or more frequencies into an ultrasonic power emission into the blood. The leaky acoustic cavity, acoustically coupled to the power transducing device and the blood, contains a first portion of the ultrasonic power emission to effect an intra-cavity ablation of atheromatous fragments while allowing a second portion of the ultrasonic power emission to leak outside thus effects an extra-cavity ablation of atheroma along the blood vessel under treatment.

The power transducing device and the leaky acoustic cavity can both be geometrically configured such that their acoustic coupling forms a leaky resonant cavity under at least one operating frequency of the ultrasonic power emission.

The power transducing device includes at least one ultrasound transducer unit having at least one emitting surface and the leaky acoustic cavity includes at least one ultrasound reflector element having at least one reflecting surface. The emitting surface and the reflecting surface are disposed to spatially oppose each other. Furthermore, the emitting surface and the reflecting surface can be shaped to substantially exhibit a common center of curvature thus forms a leaky confocal resonant cavity.

The leaky acoustic cavity can further include an intervening sound reflecting bird cage, acoustically coupled with both the emitting surface and the reflecting surface, to form a stronger acoustic resonance. The bird cage also allows the circulation through of blood and its laden materials and maintains the leakage of the ultrasonic power emission outside the leaky acoustic cavity.

The bird cage can be dimensioned to further increase the reflection coefficient of oblique propagating ultrasound waves thus strengthening their acoustic resonance.

The bird cage can further include a sound reflecting protective shield, in the form of a cylindrical shell of length shorter than that of the bird cage and mounted around the waist of the bird cage, to further strengthen the acoustic resonance.

Both the bird cage and the protective shield can be dimensioned such that acoustic jet streams formed from the collapse of cavitations generated near the center of the bird cage will glance a blood vessel wall that is substantially parallel to the longitudinal bars of the bird cage. This insures the differential ablation of the inelastic atheroma while leaving the elastic healthy intima lining intact. Simultaneously, this also reduces an otherwise risk of damaging the healthy intima lining from nearly normal-incident acoustic jet streams.

The leaky acoustic cavity can further include a microbubble releasing device, collocated with the bird cage, to release ultrasound contrast microbubbles into the blood to lower the cavitation threshold and to intensify the formation of cavitations thus enhances the ablation of atheroma.

The microbubble releasing device can be configured so that the ultrasound contrast microbubbles are injected from the interior surface of the protective shield and directed toward the center of the bird cage thus creating the desired cavitations and acoustic jet streams substantially behind the protective shield away from a nearby intima lining to avoid an otherwise risk of puncturing the healthy elastic tissues of the intima lining.

The microbubble releasing device can further include a drug injecting device for injecting desired drugs, such as anticoagulant drugs or saline, into the blood during operation.

The leaky acoustic cavity can further include a trapping and emulsification device, disposed within and around the ultrasound ablation manifold, to trap larger sized plagues and calcified tissue fragments created by both extra-cavity ablation and intra-cavity ablation. This will prolong time-integrated emulsification and reabsorption into the body thereafter without clogging up the downstream capillaries.

In one embodiment, the trapping and emulsification device includes a trapping manifold located interior to the bird cage and having a multitude of well-placed physical barriers adapted to occlude or impede the movement of the larger sized plagues and calcified tissue fragments. The multitude of physical barriers can be made of circular or rectangular grid of thin wires, supported by the bird cage, whose wire diameter is made small enough to not impede the propagation of the ultrasonic power emission. In another embodiment, the trapping and emulsification device is the combination of the bird cage and the protective shield hence making the combination multi-functional. In yet another embodiment, the trapping and emulsification device can be a fluid pumping device located inside the ultrasound ablation manifold for creating a local blood vortex sucking the larger sized plagues and calcified tissue fragments into the trapping and emulsification device thus increases its effectiveness.

The leaky acoustic cavity can further include a local blood circulation device, disposed around the ultrasound ablation manifold, to stimulate both an intra-cavity circulation and an extra-cavity circulation of the blood. This will prolong the time-integrated emulsification of the larger sized plagues and calcified tissue fragments while significantly reducing the viscous resistance to the natural blood flow from the obstructive presence of the ultrasound ablation manifold.

The ultrasound catheter device can further include a user-interfaced positioning device, affixed to the ultrasound ablation manifold, for controllably positioning the ultrasound ablation manifold in close proximity to any diseased blood lumen. This will further increase the ablation efficacy while allowing the trapping and emulsification device to more effectively trap the larger sized plagues and calcified tissue fragments.

The one or more frequencies of the high frequency power electrical signal can be further arranged into a time-varying frequency sweeping over a pre-determined range that contains one or more resonant frequencies of the ultrasound ablation manifold thus increases the intensity of the ablation process.

### BRIEF DESCRIPTION OF THE DRAWINGS

Various other objects, features and attendant advantages of the present invention will become fully appreciated as the same becomes better understood when considered in conjunction with the accompanying drawing, in which like reference characters designate the same or similar parts throughout the several views, and wherein:

FIG. 1 illustrates an embodiment of the intravascular ultrasound catheter ablation device in accordance with the present invention;

FIG. 2 is a sectional view of a power transducing device located at the distal end of the catheter;

FIG. 3 illustrates the power transducing device together with an opposing ultrasound reflector element forming an ultrasound resonant cavity when certain geometrical relationships are satisfied;

FIG. 4 is a perspective view of the ultrasound ablation manifold having an ultrasonic transducer, an ultrasound reflector element and a bird cage;

FIG. 5 is a perspective view of the ultrasound ablation manifold with the addition of a protective shield;

FIG. 6 shows a side view of the ultrasound ablation manifold with the addition of a microbubble/drug delivering tube plus a cross sectional view and a perspective cut-away view of a microbubble/drug injection ring located just inside the protective shield;

FIG. 7 is a conceptual illustration of a distribution of microbubble concentration as well as the ultrasound intensity distribution accompanying the microbubble injection;

FIG. 8 illustrates the ultrasound ray trajectories as the ultrasound wave undergoes multiple reflections from both the transducer and the reflector surfaces, as well as from the longitudinal bars of the bird cage and the blood vessel wall;

FIG. 9 illustrates how local blood convective cells are formed from the natural circulation of blood around streamline shaped surfaces of the ultrasound reflector element, the power transducer device and the ultrasound resonant cavity;

FIG. 10 illustrates that with the addition of internal physical barriers, the blood convection and small particulates will not be significantly affected while the flow of larger debris fragments will slow down;

FIG. 11 illustrates how a micro fluid pumping device added within the resonant cavity of the ultrasound ablation manifold can enhance the local blood circulation;

FIG. 12 illustrates an embodiment of electrokinetic pump for the micro fluid pumping device;

FIG. 13 is a cross sectional view of an embodiment of electrohydrodynamic pump for the micro fluid pumping device;

FIG. 14 shows an example of how an ultrasound ablation manifold would look like when it is sitting on top of an atheromatous growth;

FIG. 15 shows how, with the addition of positioning balloons, the ultrasound ablation manifold can be positioned onto a diseased area through proper inflation and deflation of the appropriate balloons;

FIG. 16 is a more detailed perspective depiction of the positioning balloon module;

FIG. 17 is a cross sectional illustration of the catheter with its multiple inner lumens; and

FIG. 18 illuminates in detail how positioning balloons work within a blood vessel lumen.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well-known methods, procedures, materials, components and circuitry have not been described in detail to avoid unnecessary obscuring aspects of the present invention. The detailed description is presented largely in terms of simplified two dimensional views. These descriptions and representations are the means used by those experienced or skilled in the art to concisely and most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of process flow representing one or more embodiments of the invention do not inherently indicate any particular order nor imply any limitations of the invention.

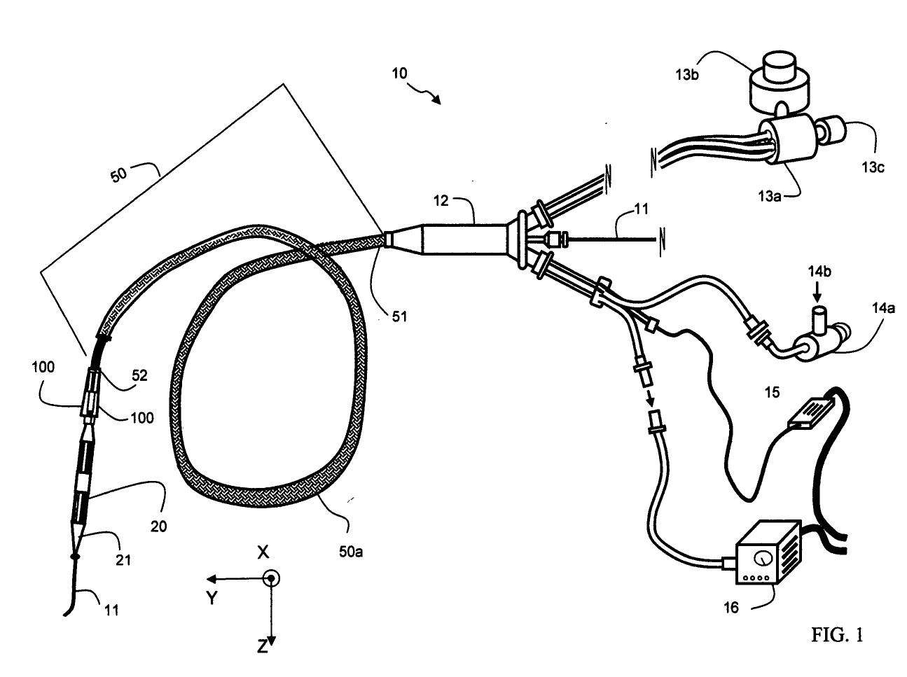

Turning now to the drawings, FIG. 1 shows an embodiment of the intravascular ultrasound catheter device 10 of the present invention for removing unhealthy lipid rich and calcified deposits inside blood vessels of human and animals. The intravascular ultrasound catheter device 10 includes an elongated catheter tube 50 with a catheter proximal end 51 and a catheter distal end 52. The catheter tube 50 is further contained in a catheter sheath 50a. An adaptor 12 is connected to the catheter proximal end 51 and an ultrasound ablation manifold 20 is connected to the catheter distal end 52.

A guide wire 11, threading through the lumen of the catheter tube 50, extends proximally beyond the adaptor 12 and distally beyond a streamlined distal tip 21 of the ultrasound ablation manifold 20. Following the guidance of the guide wire 11, the catheter tube 50 can pierce a blood vessel under treatment and reach an atheromatous area therein for treatment. A set of positioning balloons 100 are mounted just beyond the distal end of the catheter tube 50. The positioning balloons 100 are pneumatically controlled near the proximal end of the adaptor 12 by a position controller 13a via a position control knob 13c as the user interface. As a user interface, numerous alternative embodiments of the position control knob 13c such as computer keyboard, computer mouse, computer touch pad, computer input tablet or joystick can be individually employed or used in combination. The position controller 13a sends control data to a digitally controlled compressor unit 13b to individually pressurize the plurality of positioning balloons 100. In this embodiment, pressurized fluids are delivered to the positioning balloons 100 through a multitude of inner lumens within the catheter tube 50. While it is preferred to use fluid as the media to effect the pneumatic control, it is remarked that gas can be employed as the media instead. More detailed functionality of the positioning balloons 100 will be presently described. A radio frequency signal generator 16 as well as a power supply 15 are provided to feed RF and DC power through RF coax cables and DC wires located inside one of the inner lumens of the catheter tube 50 for delivery to the ultrasound ablation manifold 20 to power an ultrasonic power transducing device as well as a micro fluid pumping device internal to the ultrasound ablation manifold 20. More related details will be presently described. In addition, a drug dispensing valve 14a is also provided to meter drug and microbubble source 14b to the ultrasound ablation manifold 20 through additional inner lumens of the catheter tube 50. An example of the drug is an anticoagulant drug for preventing blood coagulation during the treatment of atheroma. Microbubbles can be used as a contrast agent for ultrasound imaging and, inter alia, are referenced by the following two articles:
1. “Targeted delivery of gas-filled microspheres, contrast agents for ultrasound imaging”, A. L. Klibanov, Advanced Drug Delivery Reviews, 37, 139-157 (1999).
2. “Therapeutic applications of microbubbles”. E. C. Unger, T. O. Matsunaga, T. McCreery, P. Schumann, R. Sweitzer, and R. Quigley, European Journal of Radiology 42, 160-168 (2002)
   However, the present invention proposes to employ microbubbles to intensify ultrasound induced cavitations in the blood thus improving the efficiency of ablating the atheroma and will be presently described in more detail. The catheter tube 50 should be made of biocompatible material that includes, but not limited to, nylon, polyurethane, polyamide, and the catheter tube 50 can have an outside diameter in the range of 3 French to 10 French.

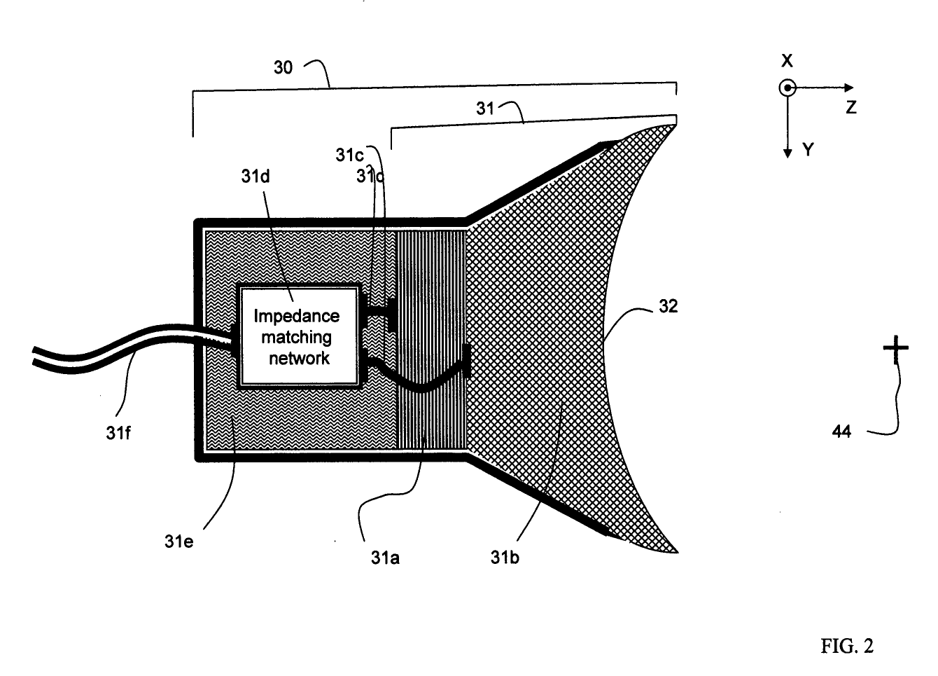

The ultrasound ablation manifold 20 includes one or more ultrasonic power transducing device 30 located at the distal end of the catheter tube 50 and FIG. 2 is a sectional view of such a power transducing device 30. The power transducing device 30 includes a piezoelectric ceramics 31a typically made of a multi-layer piezoelectric ceramic material separated by interdigitated driving electrodes. The feed circuit for the piezoelectric ceramics 31a includes signal cables 31c and an impedance matching network 31d to maximize the output power from the piezoelectric ceramics 31a while minimizing an input reflection. A coax cable 31f, located and connected to the input side of the impedance matching network 31d, carries a high frequency power electrical signal of one or more frequencies generated by the signal generator 16. The back side of the piezoelectric ceramics 31a is filled with an insulating backing material 31e to absorb an unwanted back ultrasound power emission. The front face of the piezoelectric ceramics 31a is acoustically coupled tightly to an acoustic lens 31b with an emitting surface 32. The acoustic lens 31b is made of a stiff material that has a much higher sound speed than the typical 1540 m/s (meters/second) speed of acoustic propagation in the blood. As a result, the emitting surface 32 of the acoustic lens 31b exhibits an acoustic wave propagation phase that is nearly identical to the phase front of the emitted ultrasonic wave. Hence the center of curvature of the emitting surface 32 is substantially the focus 44 of the ultrasound beam emitted from the ultrasound transducer unit 31 made of the piezoelectric ceramics 31a and the acoustic lens 31b. In essence, the ultrasound transducer unit 31 converts the high frequency power electrical signal into a focused ultrasonic power emission into the blood.

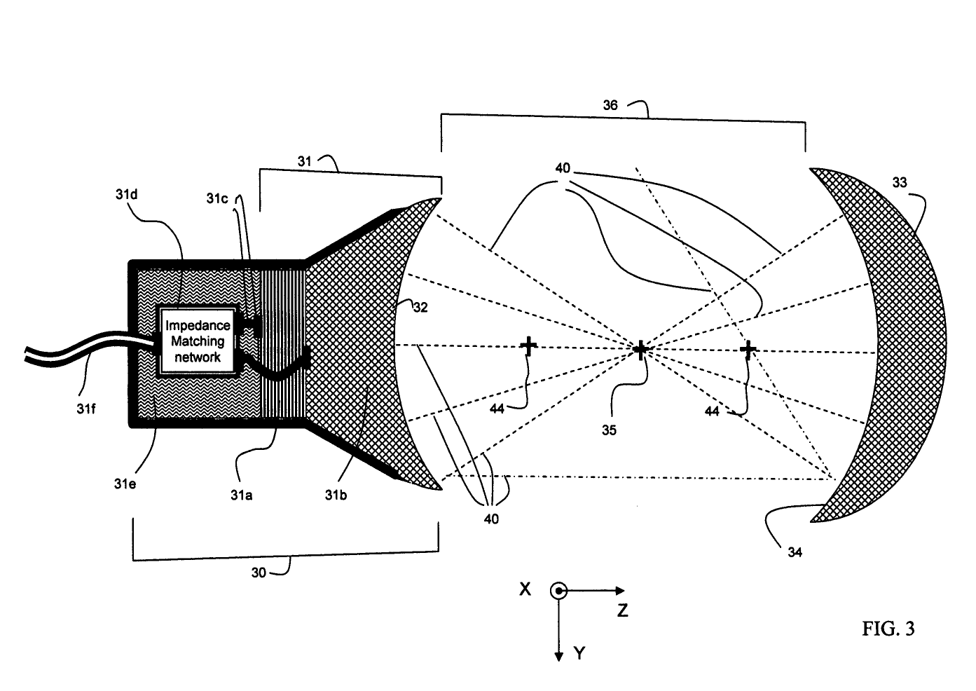

With the addition of an opposing ultrasound reflector element 33 whose center of curvature 35 is nearly coincident with that of the ultrasound transducer unit 31, as shown in FIG. 3, the combination forms a confocal ultrasonic resonant cavity 36 for the ultrasonic power emission 40. The quality factor Q of the confocal resonant cavity 36 depends largely on the aperture of the emitting surface 32 and that of the reflecting surface 34. For apertures not much larger than the wavelength of the ultrasonic power emission 40, which is likely to be the case for ultrasound frequencies in the range of 750 KHz to 3 MHz, the Q-factor would be relatively low. For higher ultrasound frequencies, the effect of wave diffraction becomes less important and the Q-factor improves (becomes higher). The Q-factor is a measure of the “quality” of a resonant system. Resonant systems respond to frequencies close to their natural frequencies much more strongly than they do to other frequencies. Under the present invention, the ultrasound Q-factor is equal to the ratio between the stored energy within the confocal resonant cavity 36 and the input energy per period of the ultrasonic power emission 40 wave. In effect, at a resonance frequency of the confocal resonant cavity 36, the ultrasound energy intensity within the confocal resonant cavity 36 is enhanced by a factor of Q over the value it would have were the confocal resonant cavity 36 not present. For the case of constant wave speed, which is approximately true for ultrasound wave propagation, an equivalent statement is that the resonance effectively increases the ultrasound power within the confocal resonant cavity 36 by the factor of Q. Clearly, a large Q-factor drastically lowers the power threshold for ultrasound induced cavitations at resonance. Due to the limited aperture of both the emitting surface 32 and the reflecting surface 34, certain ultrasound beams within the confocal resonant cavity 36 are bound to propagate, or leak, outside the confocal resonant cavity 36 as illustrated by some obliquely-propagating ultrasonic power emission 40. Hence, in addition to containing an intra-cavity portion of the ultrasonic power emission 40 for effecting an intra-cavity ablation mode of atheromatous fragments, this leaky confocal resonant cavity 36 also allows an extra-cavity portion of the ultrasonic power emission 40 to leak outside for effecting an extra-cavity ablation mode of atheroma atop a nearby blood vessel wall. For those skilled in the art, the formation of the confocal resonant cavity 36 can be formed with more than one emitting surfaces and/or more than one opposing reflecting surfaces. Furthermore, the confocal resonant cavity 36 can become resonant under multiple operating frequencies of the ultrasonic power emission 40 each with its respectively different Q-factor. It is further remarked that, while the emitting surface 32 is implied, by the location of the coax cable 31f, to be disposed near the proximal end of the ultrasound ablation manifold 20 and the reflecting surface 34 is therefore implied to be disposed near the distal end of the ultrasound ablation manifold 20, there is really no fundamental functional reason against an alternative embodiment wherein the emitting surface 32 is instead disposed near the distal end of the ultrasound ablation manifold 20 and the reflecting surface 34 is disposed near the proximal end of the ultrasound ablation manifold 20. Additionally, while it is highly power efficient to employ the confocal resonant cavity 36 to achieve the dual ablation mode, the resonant cavity does not have to be confocal. For example the emitting surface 32 and/or the reflecting surface 34 can be made with a different curvature or even a flat surface. Furthermore, the cavity does not even have to be resonant with the consequence of a correspondingly lower Q-factor thus lower power efficiency. On the other hand, the flat emitting and/or reflecting surfaces will advantageously be cheaper to make and are expected to produce a higher ultrasound intensity near the cavity boundary which will enhance the extra-cavity ablation mode. In essence, the present invention proposes a leaky acoustic cavity to effect the just described dual ablation mode.

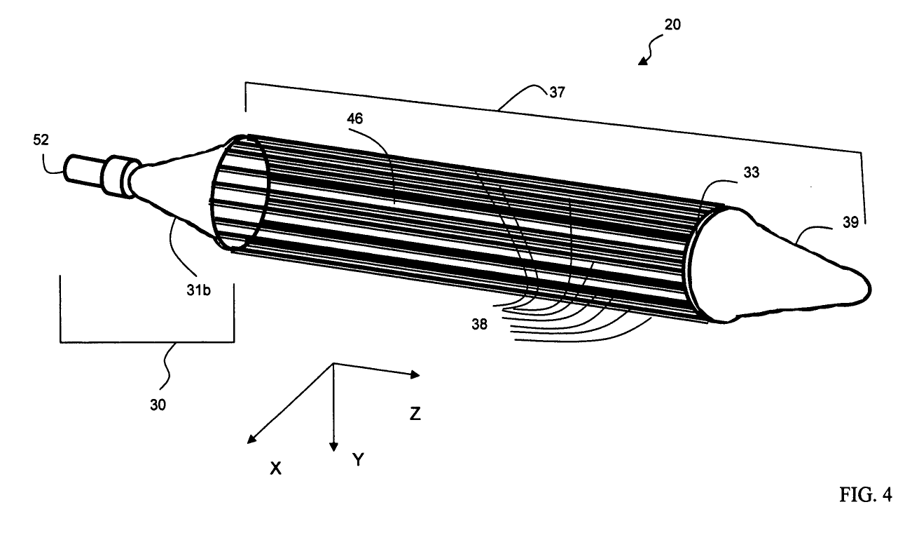

The Q-factor of the confocal resonant cavity 36, or in general simply a leaky acoustic cavity as remarked above, can be further improved by enclosing the intervening space between the emitting surface 32 and the reflecting surface 34 within a sound reflecting bird cage 37 and this is illustrated with the perspective view of FIG. 4. The bird cage 37 includes a number of peripherally distributed parallel longitudinal bars 38, along the Z-direction. To be sound reflecting, the longitudinal bars 38 should be made of materials that are stiff with respect to its ultrasonic oscillation. Such materials have a much higher sound propagation speed than that of the blood. This ensures that the longitudinal bars 38 are good sound reflectors. The pitch between adjacent bars, P_{BC}, should be made considerably smaller than the wavelength of the ultrasound, and the bar diameter, D_{BC}, should not be much smaller than the pitch between adjacent bars. Such a bird cage construction with parallel longitudinal bars 38 is especially effective in reflecting obliquely propagating ultrasound waves, waves that travel nearly parallel to the Z-axis, for which the reflection coefficient can approach one. As an example, a bar diameter D_{BC} of 0.1 mm or more in combination with a pitch D_{BC} of 0.4 mm will exhibit a reflection coefficient of more than 95% for an ultrasound frequency of 1 MHz even for an incident angle of 0 degree. However, the reflection coefficient will drop down to 81% at 2 MHz, and 58% at 3 MHz. Nonetheless, for an incident angle of 61 degrees, the reflection coefficient increases to 90% at 3 MHz, and 99% at 1 MHz. At a 80 degree incident angle, the reflection coefficient is higher than 98.7% for frequencies of 3 MHz or less, and is 95.6% at 5 MHz. This is based upon the same principle for grid or mesh antennas in microwave technology where the distributed structural holes do not affect much the performance of the antennas except to make them much lighter in weight. In essence, the addition of the bird cage 37 to the ultrasound ablation manifold 20 greatly enhances the confinement of the ultrasonic power emission 40 within the improved ultrasound resonance cavity 46, raising its Q-factor in the process. Equally important is that the bird cage 37 continues to allow the circulation through of blood and its laden materials such as atheromatous fragments produced by the ablation process. Likewise, the bird cage 37 structure also maintains the leakage of the ultrasonic power emission 40 outside the ultrasound resonance cavity 46. By now it should become clear that numerous variations of the bird cage 37 exist that can perform similar functions albeit with a correspondingly varied degree of effectiveness. A first example is a number of longitudinally connected sound reflecting rings each lies substantially in the X-Y plane. A second example is a helical spring-like structure along the Z-axis. A third example is a cylindrical shell with holes distributed around its surface. A fourth example can be a semi-permeable membrane that can allow cavitations and their induced acoustic jet streams to tunnel through without hindrance but can otherwise block or reflect ultrasound waves with a controlled leakage probability. Another feature of the present invention is that the outer surface of the ultrasound reflector element 33, now considered part of the bird cage 37, can be made into a streamline shape 39 to minimize an associated viscous drag on the natural blood flow within the blood vessel under treatment and to encourage the formation of a convective cell structure within the bird cage 37.

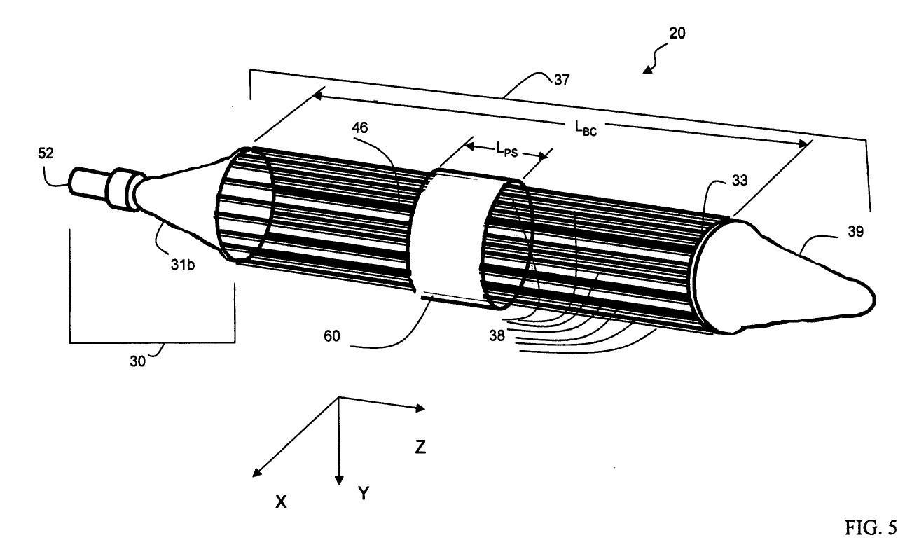

A safety concern related to the bird cage 37 structure is that it might not adequately protect the blood lumen wall against a direct exposure to normal or nearly normal incident ultrasound waves emanating from the focal region of the ultrasound resonance cavity 46. Such normal-incident ultrasound waves have a much higher chance of diffracting through the longitudinal bars 38 and reaching the blood lumen wall. Direct exposure of blood lumen wall to high intensity ultrasonic beam can potentially create intense cavitational events which could damage the lumen wall tissue. In a preferred embodiment, a sound reflecting protective shield 60 is added as part of the bird cage 37 by mounting the protective shield 60 around the waist of the bird cage 37 and this is illustrated with the perspective view of FIG. 5. In this embodiment, the protective shield 60 is in the form of a substantially cylindrical shell of length L_{PS} that is shorter than the corresponding length LBC of the bird cage 37. The protective shield 60 not only shields against direct incidence of intense ultrasound beam and its attendant cavitations onto the lumen wall tissue, it also provides two significant additional benefits. First, a protective shield 60 made of an acoustically stiff material also serves as an excellent reflector of sound wave, even against normal-incident sound waves. In this way, the ultrasound energy leakage from the ultrasound resonance cavity 46 is reduced and its Q-factor is accordingly increased. Second, in addition to a direct ultrasound incidence on the lumen wall, concomitant high-speed acoustic jet streams generated by collapsing cavitations can also impinge upon the blood vessel wall at or near a normal angle in the absence of the protective shield 60. The presence of the protective shield 60 blocks such normal-incident acoustic jet streams from causing a possible injury to the blood vessel wall as it would be considerably harder for the blood vessel wall to duck out of the way of a near normal blow from the speedy acoustic jet streams than the case of a glancing blow. Quantitatively, a preferred embodiment of the bird cage 37 includes an L_{BC} from about 5 mm (millimeter) to about 50 mm, a D_{BC} from about 200 μm (micron, 10⁻⁶ meter) to about 2000 μm and a D_{BC} from about 50 μm to about 500 μm. Correspondingly, L_{PS} is from about 1 mm to about 10 mm.

As an instructional background information, the physics behind the generation of acoustic jet streams will be briefly described. The sudden collapse of an ultrasound induced cavitation can also generate extremely high point-like pressure nearby just before the formation of asymmetric high-speed acoustic jet streams. These high-speed acoustic jet streams are created by the violent collapse of the cavitation. As the cavitation collapses, a Rayleigh-Taylor instability sets in and it begins to deform the spherical cavitation geometry into an asymmetric shape, most likely a figure eight (or more precisely, a dumbbell) shape as that corresponds to the lowest order mode of the instability (the strongest). The asymmetric shape soon develops into two separate highly compressed gas bubbles whose internal temperature can be around 300 degree Celsius. Once the gaseous pressure becomes large enough to reverse the collapsing process, the inrush fluid momentum ceases and the gas bubbles begin to expand so rapidly that they literally explode. By this time the gas bubbles are already moving away from each other, and respectively carries some surrounding fluid with them. Meanwhile, the explosion accelerates the fluid into the form of a tear drop with jet-like speeds. Initially the tear drop shapes like a sharp pin traveling at its maximum speed. Soon it starts to carry more and more fluid with it as it slows down and expands in width. The longer it travels, the slower it gets and the bigger and wider it becomes. Hence the acoustic jet streams formed closest to the blood vessel wall are the most potent ones, and we need to make sure that they aim at the wall at a glancing angle to avoid damaging the blood vessel wall. By controlling the creation of cavitations and formation of acoustic jet streams such damage can be minimized and this will be presently described. Those acoustic jet streams formed further away are not as potent but as they strike at the blood vessel wall from a more nearly normal direction, they can also shatter and fracture inelastic soft or even hard, calcified tissues by percussion force. To further increase the intensity of the ablation process, the numerous frequency components of the ultrasonic power emission 40 can be arranged into a time-varying frequency sweeping over a pre-determined range that contains one or more resonant frequencies of the ultrasound ablation manifold 20. An estimated broad frequency sweeping range is from 200 KHz to 20 MHz. A preferred sub-range is from 500 KHz to 5 MHz. An estimated way of sweeping the frequency range is performing a pseudo-random sweeping with a repetition rate higher than 1 Hz.

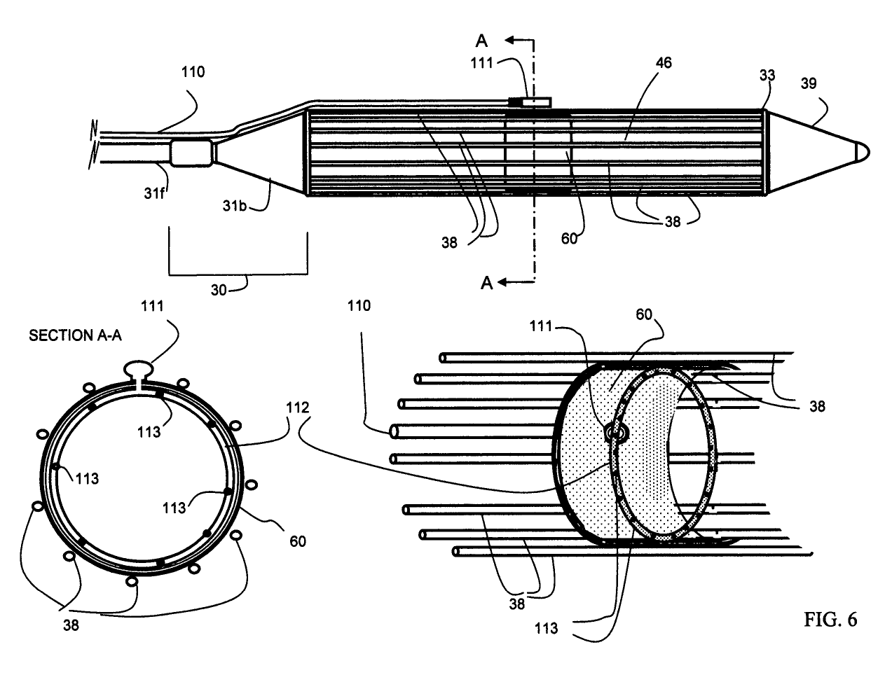

To further improve the ablation geometry afforded by the protective shield 60 and to control the distribution of ultrasound induced cavitations and their subsequently formed acoustic jet streams, a microbubble/drug injection ring 112, with a plurality of built-in bleed holes 113 for releasing microbubble contrast agent as well as anticoagulant drug or saline, generically called an effluence, is mounted on the inside surface of the protective shield 60. This is depicted in various views of FIG. 6. A microbubble/drug injection tube 110 is contained in one of the inner lumens of the catheter tube 50 that feeds the desired microbubble contrast agent or drug to the waist of the protective shield 60, wherein the effluence enters a microbubble/drug injector inlet 111 through the wall of the protective shield 60 to the periphery of the microbubble/drug injection ring 112. Microbubbles have been used extensively as a medical imaging contrast agent because they do not contain chemicals hence are considered safe. However, in the presence of strong enough ultrasonic power emission, microbubbles can become the “seed nuclei” for cavitations with the consequence that the corresponding cavitation threshold could be drastically lowered. This means that, under the same intensify of the ultrasonic power emission 40 within the ultrasound resonance cavity 46, the formation of cavitations is drastically intensified enhancing the ablation of atheroma.

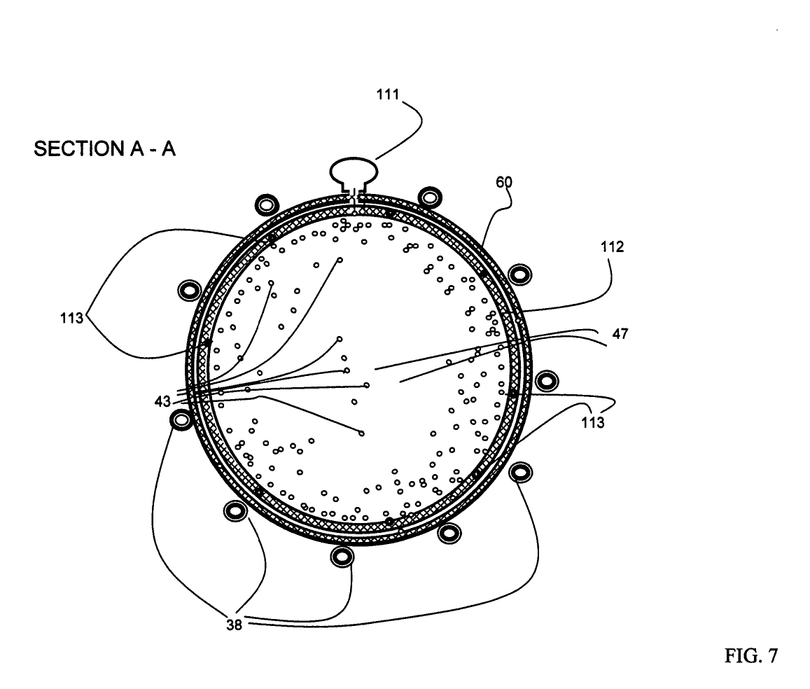

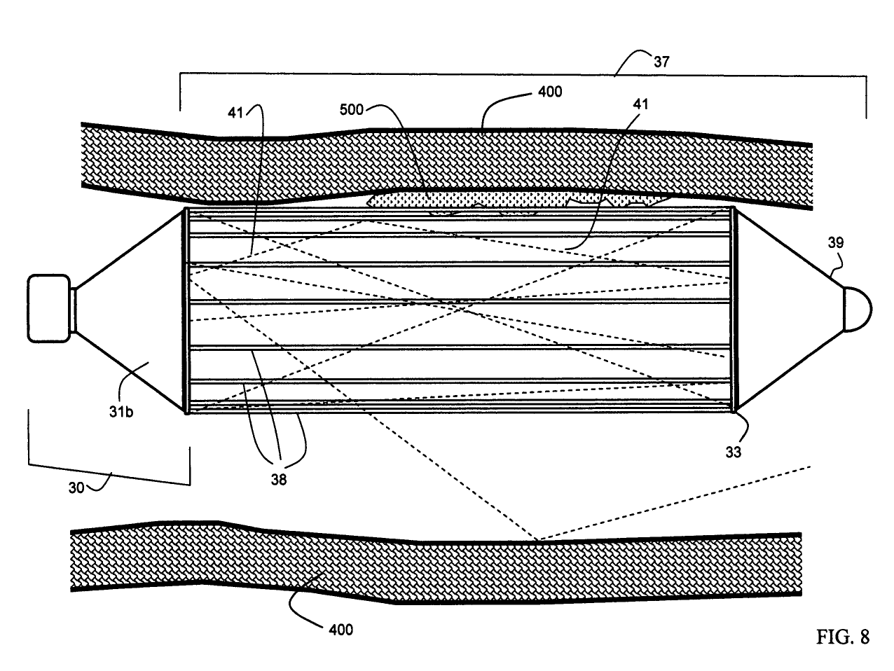

As microbubbles 43 emerge from the bleed holes 113 around the periphery of the microbubble/drug injection ring 112, the microbubbles 43 interact with the nearby intense ultrasonic energy field that causes a percentage of the microbubbles 43 to resonate violently into cavitations. The corresponding distribution of microbubbles 43 concentration as well as the ultrasound intensity distribution accompanying the microbubble injection are conceptually illustrated in FIG. 7. To further complement the understanding of the functionality of the microbubbles 43 as are employed in the present invention, FIG. 8 illustrates, with the protective shield 60 removed for clarity, the various ultrasound ray trajectories as the ultrasound wave undergoes multiple reflections from both the acoustic lens 31b and the ultrasound reflector element 33, as well as from the longitudinal bars 38 of the bird cage 37 and the blood vessel wall 400. Notice that, owing to the geometry of the ultrasound resonance cavity 46, the high intensity ultrasound regions 47 are predominantly concentrated near the center of the cavity. The average distance the microbubbles 43 travel before cavitations occur is determined by how close the microbubble natural surface oscillation frequencies are to the frequency of the ultrasonic power emission 40. This average distance can also be controlled by pulsing the ultrasonic power emission 40 and timing pulsed releases of the microbubbles 43 accordingly. As illustrated, to insure that the majority of the high-speed acoustic jet streams glance the blood vessel wall 400 as represented by the oblique propagating ultrasound waves 41 instead of attacking normally at the blood vessel wall 400, the cavitation events should preferably be limited to a region immediately behind the protective shield 60. This is accomplished by injecting the microbubbles 43 substantially from just inside the protective shield 60 toward the center of the bird cage 37. On the other hand, this does not preclude the occurrence of strong cavitations near the center/focal point of the bird cage 37 because as the remaining microbubbles 43 travel toward the center of the bird cage 37, they continuously change their shapes, sizes and hence their resonant frequencies, therefore some of them are bound to reach resonance with the ultrasonic power emission 40 near the center of the ultrasound resonance cavity 46. Those high-speed acoustic jet streams generated by the cavitation events near the center of the bird cage 37 need to travel a long distance to reach the blood vessel wall 400, if at all. Furthermore, as a high-speed acoustic jet stream travels through the stagnant blood inside the bird cage 37, the high-speed acoustic jet stream broadens and loses its speed. By the time it reaches the blood vessel wall 400, its impact is blunted and can be easily deflected by the elasticity of the blood vessel wall 400. Meanwhile, hard, calcified tissue from the atheroma 500 would still be unable to deflect away and would likely be shattered under the high pressure of impact generating microfractures. Soft, lipid rich tissue deposits from the atheroma 500 are also inelastic and would likewise be ablated. By contrast, high-speed acoustic jet streams generated near and behind the protective shield 60 wall without significant attenuation can only predominantly glance the blood vessel wall 400. The impact of such a glancing acoustic jet stream on the blood vessel wall 400 creates strong local velocity shear that in turn causes the contacted wall material to deform severely. Again, the atheroma 500 on the wall will be unable to follow such deformation and will fracture and subsequently shatter. Should acoustic jet streams get underneath a gap between the inelastic, calcified tissue and the otherwise healthy, smooth muscular wall tissue, the calcified tissue can be lifted into the blood stream much like the roof tiles getting lifted off by gusty wind blowing at the roof.

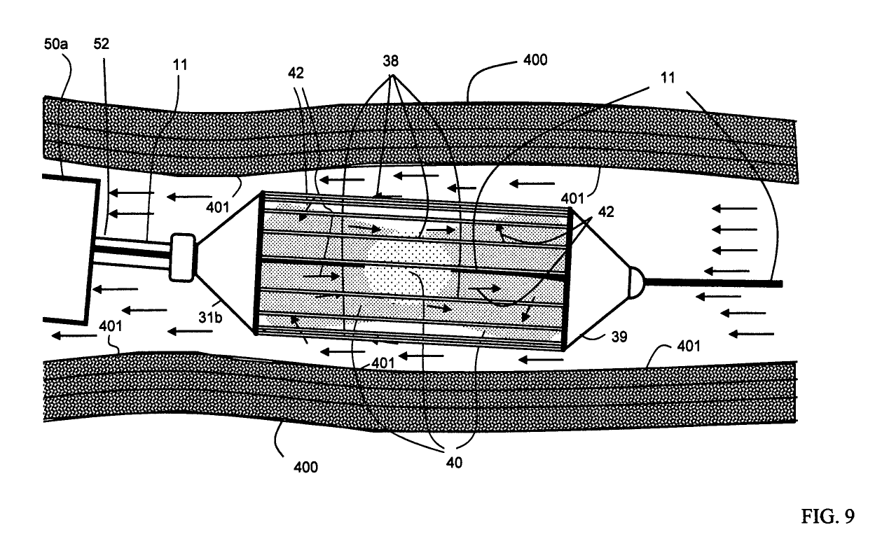

One of the major concerns in atherectomy is the impact of the procedure has on zones proximal and distal to the ultrasound treatment area during operation. The fast removal of atheroma 500 tissue by ultrasound can generate a significant amount of microparticulate debris as well as clot formation. It is important that the sizes of the particles are made small enough to allow them easily pass through micro capillaries. Although the majority of the atheromatic fragments generated from the ablating process may be small enough, some larger fragments are also invariably produced. It is therefore important that these larger fragments get further pulverized before they leave the treatment area. A first way is to dispose another microbubble releasing mechanism, similar to the just-described microbubble/drug injection ring 112 with an attached microbubble/drug injection tube 110, etc., located either distal or proximal to and connected to the ultrasound ablation manifold 20, to release additional microbubble contrast agent into the blood to lower the cavitation threshold and to intensify the formation of cavitations there. In this way and in combination with an evanescent ultrasonic power emission from the ultrasound ablation manifold 20, additional cavitations are generated within the blood vessel lumen to further pulverize and emulsify such larger debris fragments that had either not entered the ultrasound ablation manifold 20 or had escaped from it. There is also strong clinical evidence that low intensity ultrasound at power levels even below that needed for cavitations can cause the blood clots to break up over time thus preventing the coagulation of the blood distal to the treatment site. A second way of further pulverizing and emulsifying such larger debris fragments is to create a local vortex of the blood convective flow. Such vortex flow can transport the debris into and out of the ultrasound resonance cavity 46 of the ultrasound ablation manifold 20. A preferred embodiment of the present invention is to shape the exteriors of the ultrasound ablation manifold 20 in such a way that the natural circulation of blood around it and along intima linings 401 forms convective cell patterns 42, as is shown in FIG. 9. While the larger fragments are circulating inside the ultrasound resonance cavity 46, they are subjected to intense ultrasound radiation from the ultrasonic power emission 40 with radiation pressure as high as a few tens of mm Hg (millimeters of mercury), or roughly 1/30^{th} of the atmospheric pressure, sufficient to tear them asunder. In addition, cavitations and their created acoustic jet streams can puncture larger sized debris and pulverize smaller sized particulates.

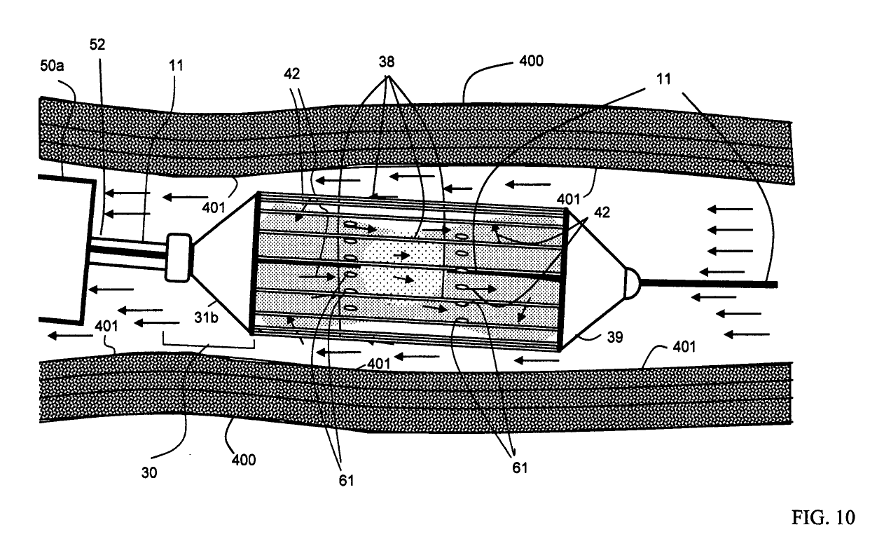

An additional procedure to handle such undesirable larger debris fragments is to cause these fragments to slow down or to trap them once they enter the ultrasound resonance cavity 46 so that they can be pulverized and emulsified until they are small enough to escape the traps. This procedure in effect prolongs a time-integrated emulsification of the larger debris fragments. One embodiment is to erect a trapping manifold having a plurality of circular or rectangular grid of extremely thin pins or wires inside and around and further supported by the bird cage 37 so that the movement of larger debris fragments is retarded while the movement of smaller particles is unaffected. Meanwhile, the ratio between the pitch of these thin pin barriers and their pin diameter should be made large enough so as not to impact the propagation of the ultrasonic power emission 40. An illustration of this embodiment using physical barriers 61 is shown in FIG. 10. By now it should also become clear that the combination of bird cage 37 and protective shield 60 also performs a similar function albeit limited to a peripheral surface area of the ultrasound ablation manifold 20.

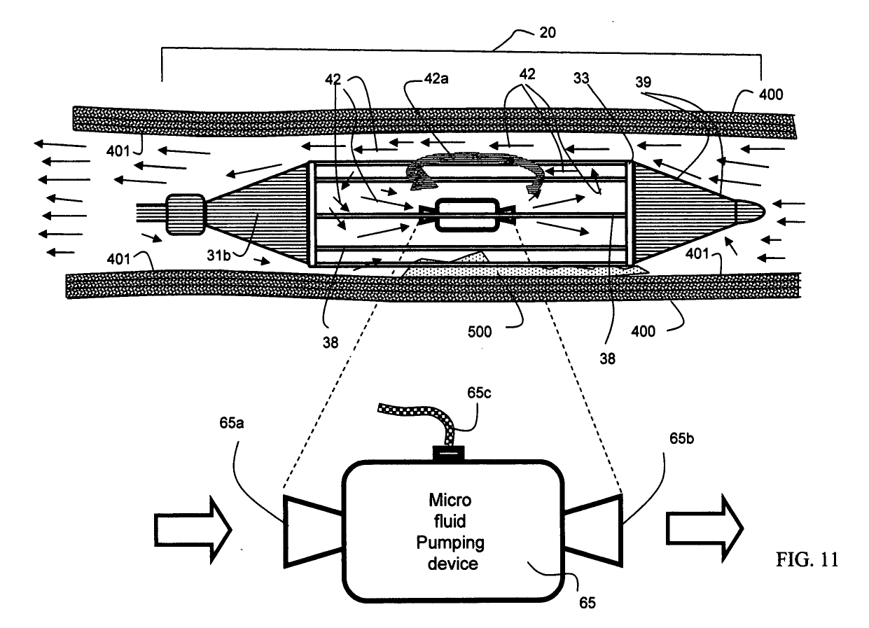

Another embodiment to further increase the effectiveness of the above trapping manifold is to add a micro fluid pumping device 65 internal to the ultrasound ablation manifold 20 to generate an intra-cavity flow opposing the natural blood circulation direction, as illustrated in FIG. 11. The micro fluid pumping device 65 forcefully creates convective cell patterns 42 in the blood, graphically indicated by an induced blood convective cell 42a, sucking the larger sized plagues and calcified tissue fragments external to the ultrasound ablation manifold 20 into its interior for a prolonged time-integrated emulsification. The fluid pumping device 65 creates a return flow which is parallel but opposite to the direction of natural blood flow. It follows that the addition of the fluid pumping device 65 can significantly reduce the viscous resistance to the natural blood flow from the obstructive presence of the ultrasound ablation manifold 20. In fact, it should be possible to control the pumping power of the micro fluid pumping device 65 to such an extent that it substantially cancels out any increase in flow resistance. In the enlarged view, the micro fluid pumping device 65 has an intake port 65a to suck in the blood, an ejection port 65b to eject the pressurized blood and is powered by either a DC or an AC power cord 65c coming from the distal end of the catheter tube 50, not shown here for simplicity. It is further remarked that, while the various embodiments related to FIG. 9 to FIG. 11 are illustrated with the blood flow coming from the distal end of the ultrasound ablation manifold 20, these embodiments remain valid for an alternative ablation environment wherein the blood flow comes from the proximal end of the ultrasound ablation manifold 20 instead.

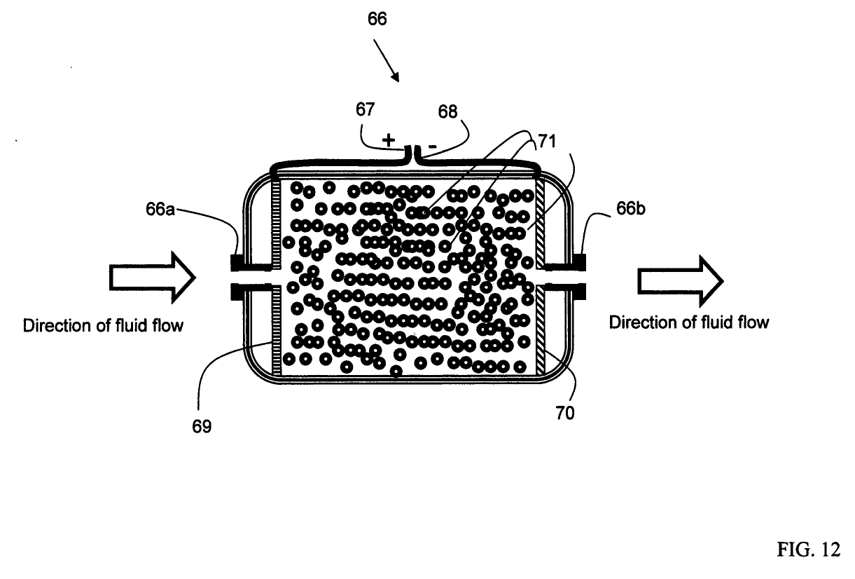

FIG. 12 illustrates an embodiment of the micro fluid pumping device 65 of the electrokinetic type which operates on the principle of electroosmosis. Inside this electroosmotic electrokinetic pump 66, a dense pack of submicron sized sintered nano silica 71 particles is sandwiched between two planar electrodes anode 69 and cathode 70. The planar electrodes have openings to allow blood to flow through. Upon contacting the blood, the sintered nano silica 71 will become negatively charged. Therefore positive ions within the blood get attracted to the negative surface charge of the sintered nano silica 71 particles to form a boundary layer of positively charged fluid with a layer thickness of a Debye length that is about a few tens of nanometers in this case. When a voltage is applied across the positive terminal 67 and the negative terminal 68, the positive ions within the blood, being mobile, will be repelled by the anode 69 near the intake port 65a and attracted by the cathode 70 near the ejection port 65b. As a significant portion of the blood inside the densely packed interior is within the Debye boundary layer, the movement of the positive ions carries the otherwise neutral blood with them thus establishing a fluid pumping action. The positive ions lose their charges upon collision with the cathode 70 while new positive ions get created at the anode 69. Such electrolytic reaction leads to the formation of gas bubbles which have the desirable effect of further stimulating the formation of cavitations much like microbubbles do. However, long termed accumulation of gaseous bubbles in the blood could lead to patient complications. By making the ejection port 65b much larger than the intake port 65a, and by using higher frequency AC power in the range of tens to hundreds of KHz to power the positive and the negative terminals 67 and 68, the gaseous emission can be greatly minimized with a corresponding loss of pumping efficiency. Electroosmotic micro-pumps have been used extensively for micro-fluidic applications where mechanical pumps are impractical due to their bulky size. Another electrokinetic type pump that can be used here is an electrophoretic pump.

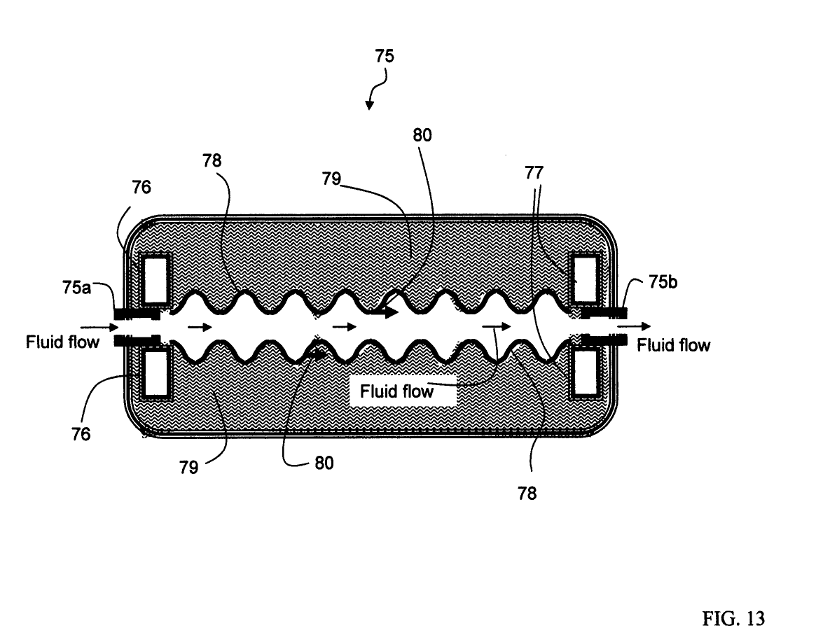

FIG. 13 is a cross sectional view of another embodiment of the micro fluid pumping device 65 that is an electrohydrodynamic pump 75. The electrohydrodynamic pump 75 includes a narrow fluid passage framed on both sides by a thin metallic foil 78 backed by an elastic substrate 79. A pair of ultrasound actuators serving as ultrasonic transmitting transducers 76 are mounted on the intake port 75a end of the pump with one end of the metallic foils 78 attached to the transmitter outputs. Another pair of ultrasound actuators serving as ultrasonic receiving transducers 77 are mounted on the ejection port 75b end of the pump with the other end of the metallic foils 78 attached to the receiver outputs. The pair of ultrasonic receiving transducers 77 functions as ultrasound receivers to prevent a traveling ultrasonic interface wave 80 from a back reflection. The pockets formed by the traveling ultrasonic interface wave 80 propel the fluid thus establishing the pumping action. An ultrasound traveling wave micropump can produce strong pumping action without parasitic gaseous emission. While not graphically illustrated here, yet another embodiment of the micro fluid pumping device 65 is a piezoelectric pump. As its name suggests, the piezoelectric pump uses a piezoelectric material for actuation and does not rely on the electromechanical properties of the fluid being pumped. A specific example is a piezoelectric copolymer pump. Yet another alternative embodiment of the micro fluid pumping device 65, still not graphically illustrated here, relies on the directivity of a radiation pressure generated by the ultrasonic power emission 40. By making the curvature of the ultrasound reflector element 33 within the ultrasound ablation manifold 20 less converging, an asymmetrical condition deviated from the otherwise symmetrical confocal resonant cavity 36 (FIG. 3) is created. This asymmetrical condition in turn generates a circulation field from the asymmetrical radiation pressure. Such a circulation field can produce a strong vortex flow with an accompanying radiation pressure difference as high as a few percent of the atmospheric pressure even under a modest ultrasonic power emission 40 of 10 watts. Better still, the thus generated pumping force is a volume force whose magnitude is a strong function of the elasticity, absorptivity and mass density of the material irradiated by the ultrasound radiation. For example, microbubbles and cavitations can scatter and attenuate ultrasound radiation effectively hence the radiation force exerted by the ultrasonic power emission 40 on them is strong. Similarly, soft, inelastic plaque lesion fragments or hard, calcified tissue fragments of the atheroma 500 both attenuate or scatter ultrasound radiation, hence the radiation force exerted on them are stronger than that which is exerted on the intima lining 401 as the latter has a much lower attenuation coefficient with respect to ultrasound wave.

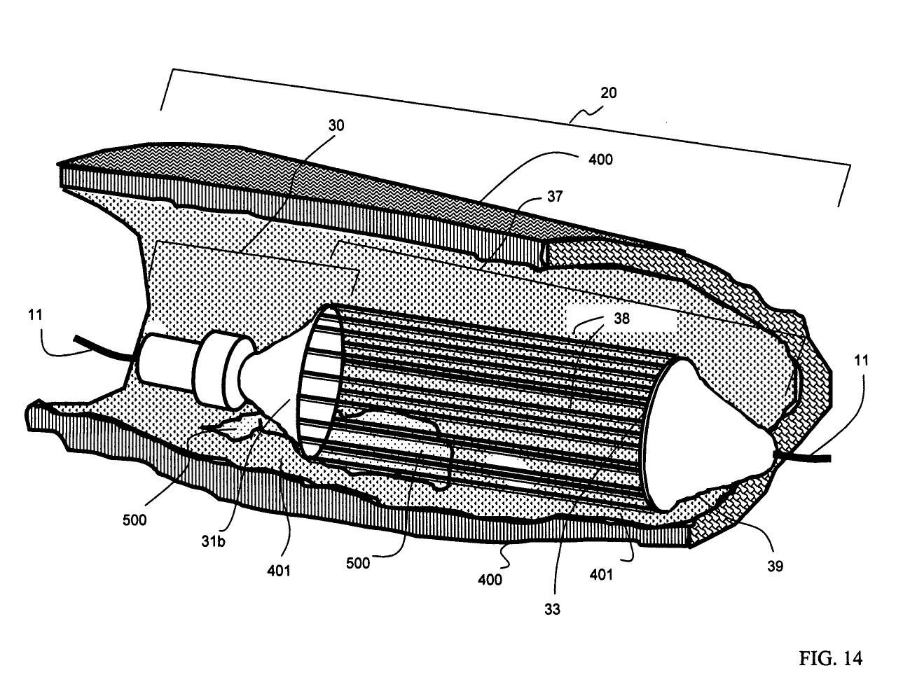

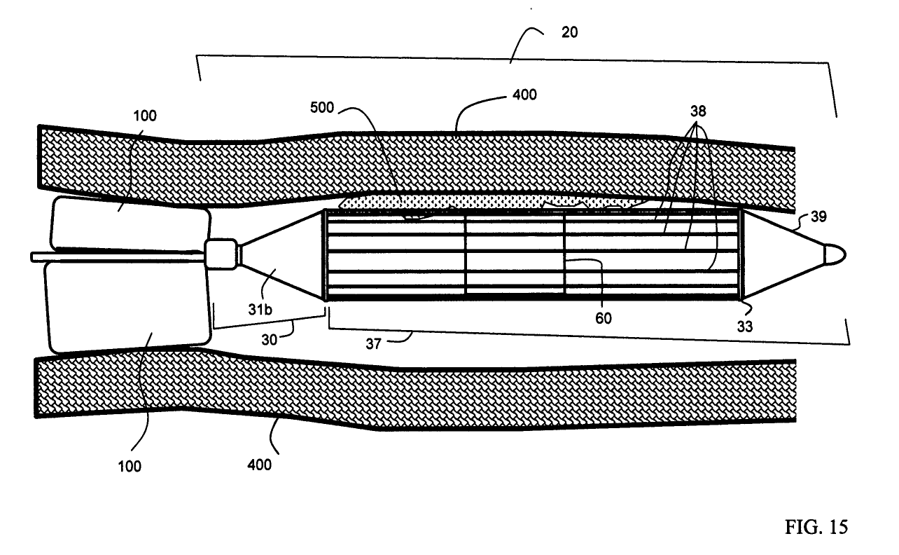

Due to the varying size of the blood vessel, an ultrasound ablation manifold 20 may be a tight fit in one section while undersized in another section of the blood vessel. To adapt to the varying size of the blood vessel lumen diameter and to consistently position the ultrasound ablation manifold 20 in close proximity to the atheroma 500 lesion thus further increasing the ablation efficacy, a vectoring mechanism can be attached to the ultrasound ablation manifold 20 to adjust the position of the ultrasound ablation manifold 20 relative to the blood vessel interior wall. An example of how the ultrasound ablation manifold 20 would look like when it is sitting right on top of an atheroma 500 atop an intima lining 401 is shown in FIG. 14. Due to the length of the guide wire 11, trying to precisely position the ultrasound ablation manifold 20 atop the atheroma 500 by manipulating just the guide wire 11 is almost impossible. However, with the addition of positioning balloons 100, FIG. 15 shows that the ultrasound ablation manifold 20 can now be accurately positioned onto an atheroma 500 growth through proper inflation and deflation of the appropriate positioning balloons 100.

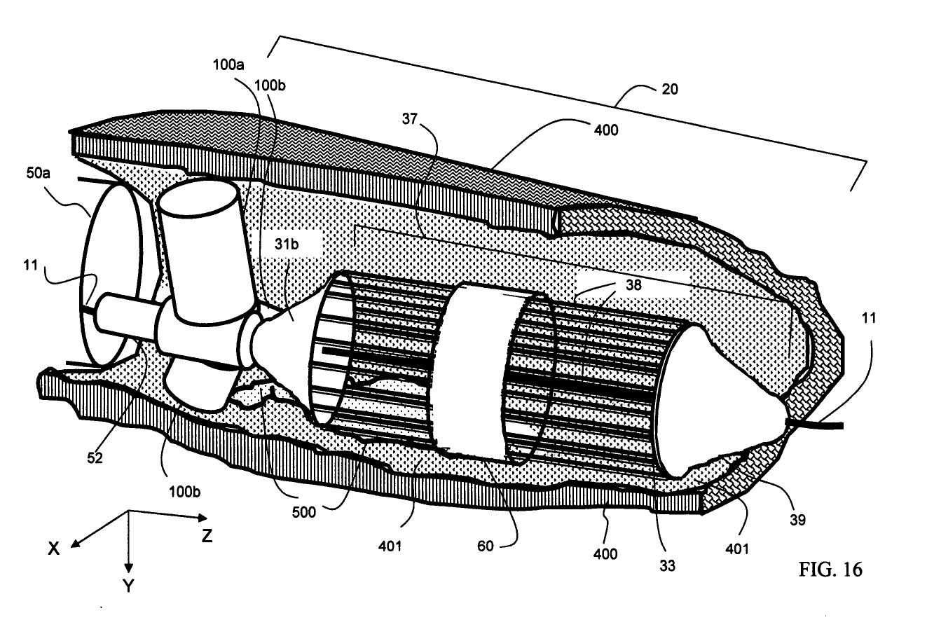

FIG. 16 is a more detailed perspective depiction of the positioning balloon module. At least three positioning balloons are needed for providing the full two degrees of freedom within the X-Y plane. In this case, a combination of one top inflated positioning balloon 100a and two bottom deflated positioning balloons 100b places the ultrasound ablation manifold 20 right atop the atheroma 500. The balloons 100a and 100b should not unacceptably obstruct or occlude natural blood circulation through the blood vessel under any circumstance. In this preferred embodiment as depicted, each balloon is constrained to have only one degree of freedom by limiting its expansion in the transverse direction along the balloon axis. One such example of the balloon shape is a bellow-shaped Chinese lantern that can only expand along its longitudinal direction. An accompanying advantage of accurately placing the ultrasound ablation manifold 20 atop the atheroma 500 is that it allows the larger sized plagues and calcified tissue fragments released from the atheroma 500 during treatment to be more effectively sucked into and trapped inside the bird cage 37 for further ablation and emulsification.

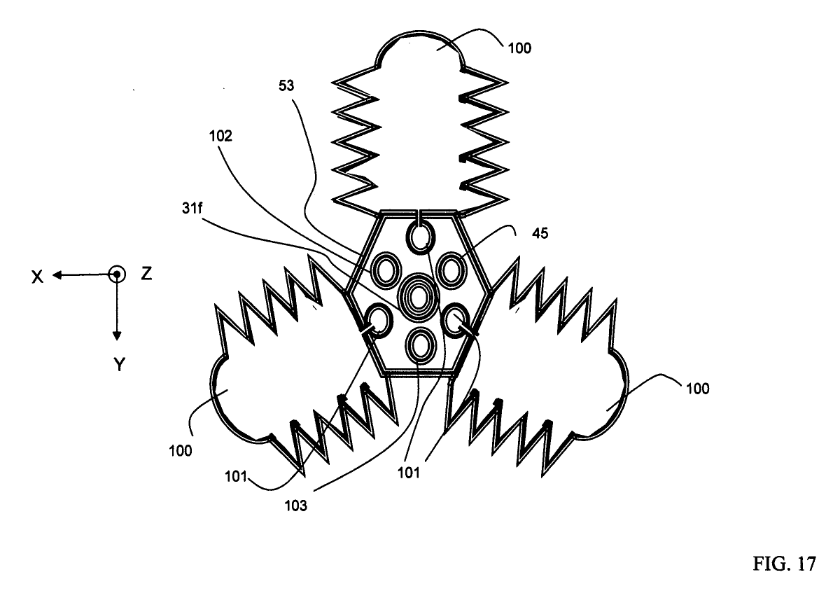

Also illustrated in FIG. 17 is a cross sectional view of the catheter tube section 53 with its multiple inner lumens. As shown, the center lumen is for carrying the coax cable 31f that provides the RF power for the power transducing device 30 as well as for the micro fluid pumping device 65. In addition, there are lumens for microbubble/drug delivery 102, DC power cable 45 and optical fiber bundle 103 for in vivo imaging of the blood vessel interior. Of course, there are three lumens 101 each carrying a pressurizing fluid for inflating its positioning balloon 100.

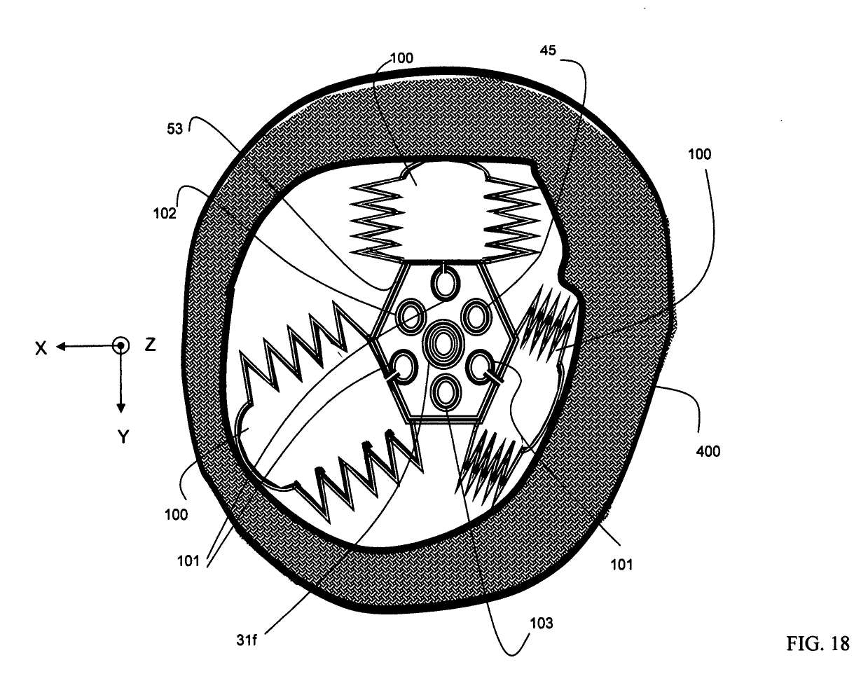

Finally, FIG. 18 illuminates in detail how positioning balloons 100 work within a blood vessel lumen. Each of the three positioning balloons 100 is in its respective stage of dilatation. By selecting a proper dilatation pressure for each balloon 100, the ultrasound ablation manifold 20 can be positioned almost at will while conforming to the shape of the inner lumen wall. An attached optical imaging lens, not shown here, provides a visual feedback to an operator via the optical fiber bundle 103. Although in general the balloons 100 can place the ultrasound ablation manifold 20 almost anywhere within the transverse X-Y plane inside the blood vessel lumen, only the angular location of the ultrasound ablation manifold 20 needs to be specified. Once the angular location is specified, the ultrasound ablation manifold 20 can be maneuvered to gently notch along the specified direction until it is pressed firmly against the vessel wall or over the atheroma 500 lesion. The fluid within the balloon pressurizing lumens 101 is regulated by the position controller 13a located near the proximal end of the catheter tube 50 to ensure that no undue pressure is exerted on the blood vessel lumen wall. The position controller 13a takes its input from the operator through the position control knob 13c and maps the angular information into pressure ratios for the individual balloons 100. The angular information is provided by turning the position control knob 13c. The knob 13c is normally fully extended outwards and this corresponds to a default normalized pressure. The actual dilatation pressures applied to the individual balloons 100 are obtained by multiplying the default pressure by the pressure ratio for the corresponding balloon. The default pressure is designed to provide just sufficient pressure for the balloons 100 to fully extend themselves while still allowing the ultrasound ablation manifold 20 to make minor longitudinal (Z-axis) and transverse (X-Y plane) adjustments with ease. Once the longitudinal and transverse adjustments have been made, the operator can push the position control knob 13c slowly inwards to firmly press the ultrasound ablation manifold 20 against the atheroma 500 for treatment. For those skilled in the art, by now it should become clear that the positioning balloons 100 can be equivalently replaced with other positioning devices such as pneumatic pistons, solenoids, digitally controllable linear slides and linear motors and still achieve functionalities similar to the above.

While the disclosure of the present invention has concentrated on using the ultrasound ablation technique to treat atherosclerotic plaques, it should be appreciated that the technique in accordance with the present invention can be utilized to treat early stage atheromatic formation with or without calcification of the intima lining as well. The same underlying principles can further be applied to the treatment of secondary body lumens such as carotid arteries where, due to the size of the ultrasound ablation manifold, a direct insertion into the treatment site is not possible. For these cases, however, the ultrasound ablation manifold can instead be advanced to a point closest to the treatment site and the irradiation of nearly collimated paraxial ultrasound beam accompanied by the release of microbubble contrast agent can still provide low intensity ultrasound induced cavitational collapses and concomitant acoustic jet streams in and around the treatment area to gradually remove the atheromatic lesion. While the blood vessel wall is normally transparent to ultrasound propagation, when an ultrasound beam strikes at the vessel wall with a glancing incident angle more than about 82 degrees, the vessel wall can reflect the ultrasound beam with near 100% efficiency. Therefore a collimated ultrasound beam traveling paraxial to the artery will be confined and guided by the artery without significant divergence. In essence, the artery acts like a waveguide for collimated ultrasound propagation. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

We claim:

1. An apparatus for ablating undesirable deposits along the inner blood vessel wall of human and animals, the apparatus comprising:
a recirculating blood delivering and injecting unit for delivering and forcefully injecting a pressurized source blood into a blood vessel under treatment to ablate undesirable deposits there from and, after the ablation, for recirculating the injected blood back for redelivery and reinjection; and
a blood extracting and pressurizing unit, in communicative connection with the recirculating part of said recirculating blood delivering and injecting unit, for extracting, pressurizing and delivering the recirculated blood as said pressurized source blood to the blood delivering and injecting part of said recirculating blood delivering and injecting unit.

2. The apparatus of claim 1 wherein, for those cases wherein said recirculating blood delivering and injecting unit further administers drugs primarily designed for treating a localized diseased area under ablation but otherwise may be undesirable if said drugs were dispersed elsewhere in the body, said recirculating blood delivering and injecting unit further automatically collects and recycles said drugs for an optional re-injection.

3. The apparatus of claim 1 wherein said recirculating blood delivering and injecting unit further comprises a series connection of a dual tube in communicative connection with said blood extracting and pressurizing unit, a secondary manifold and an injector nozzle, upon its placement into a desired portion of said blood vessel under treatment, said series connection effects the forceful ejection of the pressurized source blood into said blood vessel under treatment and effects the recirculation of a part of the injected blood back for redelivery and reinjection.

4. The apparatus of claim 3 wherein the series connection of said dual tube and said blood extracting and pressurizing unit further realizes the benefit of single point invasion into the human or animals' body thereby reduces the risk and discomfort associated with an otherwise multiple point invasion.

5. The apparatus of claim 3 wherein said blood extracting and pressurizing unit further comprises a primary manifold having a primary inlet, a primary outlet and a pumping means connected in between for receiving said source blood from said dual tube through said primary inlet and pressurizing said source blood for delivery to said dual tube through said primary outlet.

6. The apparatus of claim 5 wherein said dual tube further comprises:
a delivery tube having an upstream delivery end and a downstream delivery end with said upstream delivery end being in communicative connection with said primary outlet and said downstream delivery end being in communicative connection with said secondary manifold; and
a return tube having an upstream return end and a downstream return end with said upstream return end being located downstream of and in fluidic communication with said injector nozzle and said downstream return end being in communicative connection with said primary inlet.

7. The apparatus of claim 6 wherein said secondary manifold further comprises a reception and confinement unit located upstream of and in communicative connection with said return tube via its upstream return end, said reception and confinement unit further comprises a deflector head located downstream of said injector nozzle for deflecting and returning part of the ejected source blood there from into the upstream return end for redelivery and reinjection.

8. The apparatus of claim 7 wherein, for those cases wherein said recirculating blood delivering and injecting unit further includes an RF discharging tip near the injector nozzle, said deflector head is further made electrically conductive thereby effecting an efficient focusing and concentration of the emitted RF power from said RF discharging tip.

9. The apparatus of claim 7 wherein, for those cases wherein said recirculating blood delivering and injecting unit further includes an electrical discharge means near the injector nozzle, said reception and confinement unit is further made electrically conductive thereby allowing a bipolar discharge mode to neutralize, with higher efficiency compared to an otherwise unipolar discharge mode, excess opposite-sign charges generated from the tearing of healthy or diseased tissues during the ablating process.

10. The apparatus of claim 7 wherein said reception and confinement unit further comprises a semi-flexible interconnecting member for interconnecting said deflector head and said upstream return end.

11. The apparatus of claim 7 wherein said secondary manifold further comprises a power transducer, affixed in proximity to the tip of said injector nozzle, for converting a high frequency power electrical signal of one or more frequencies into a corresponding ultrasonic power emission into the blood to remove the undesirable deposits inside said blood vessel under treatment via pulverization and emulsification during an ablating process to remove said undesirable deposits.

12. The apparatus of claim 11 wherein said primary manifold further comprises an inline filtering means in serial fluidic communication with said primary inlet, said pumping means and said primary outlet for ridding the extracted recirculated blood of ablated plaques and calcification debris before redelivery and reinjection.

13. The apparatus of claim 7 wherein said reception and confinement unit is further shaped and sized to form, together with the injector nozzle, an ultrasonic acoustic cavity to reflect and confine said ultrasonic power emission therein thereby correspondingly increases the confined ultrasound energy density and the ablating power while limiting a potentially negative biological effect of the high power ultrasonic emission on otherwise healthy tissues located away from the diseased region under treatment.

14. An intravascular ultrasound catheter device adapted to generate cavitations and concomitant high-speed acoustic jet streams in the blood to pulverize, emulsify thus ablate atheroma, the ultrasound catheter device comprises:
an elongated catheter tube for piercing a blood vessel under treatment and reaching an atheromatous area therein for treatment; and
an ultrasound ablation manifold mounted on and near the distal tip of the catheter tube for ultrasonically ablating atheroma from said atheromatous area, said ultrasound ablation manifold further comprises:
a power transducing device for converting a high frequency power electrical signal of one or more frequencies into an ultrasonic power emission into the blood; and
a leaky acoustic cavity, acoustically coupled to said power transducing device and the blood, for containing a first portion of said ultrasonic power emission thereby effects an intra-cavity ablation of atheromatous fragments therein while allowing a second portion of said ultrasonic power emission to leak outside said leaky acoustic cavity thereby effects an extra-cavity ablation of atheroma along the blood vessel under treatment.

15. The ultrasound catheter device of claim 14 wherein said power transducing device and said leaky acoustic cavity are both geometrically configured such that the acoustic coupling there between forms a leaky resonant cavity under at least one operating frequency of said ultrasonic power emission.

16. The ultrasound catheter device of claim 15 wherein said power transducing device further comprises at least one ultrasound transducer unit having at least one emitting surface and said leaky acoustic cavity further comprises at least one ultrasound reflector element having at least one reflecting surface.

17. The ultrasound catheter device of claim 16 wherein at least one of said emitting surface and at least one of said reflecting surface are disposed to spatially oppose each other.

18. The ultrasound catheter device of claim 17 wherein said at least one emitting surface and said at least one reflecting surface are further shaped to substantially exhibit a common center of curvature there between thereby forms a leaky confocal resonant cavity.

19. The ultrasound catheter device of claim 18 wherein said at least one emitting surface is disposed near the proximal end of the ultrasound ablation manifold and said at least one reflecting surface is disposed near the distal end of the ultrasound ablation manifold.

20. The ultrasound catheter device of claim 18 wherein said at least one emitting surface is disposed near the distal end of the ultrasound ablation manifold and said at least one reflecting surface is disposed near the proximal end of the ultrasound ablation manifold.

21. The ultrasound catheter device of claim 17 wherein said leaky acoustic cavity further comprises an intervening caging means, acoustically coupled with both said emitting surface and said reflecting surface, thereby forms a stronger acoustic resonance there with while:
a) allowing the circulation of blood and its laden materials there through; and
b) maintaining the leakage of said ultrasonic power emission outside said leaky acoustic cavity.

22. The ultrasound catheter device of claim 21 wherein the structure of said caging means is made of a sound reflecting material.

23. The ultrasound catheter device of claim 21 wherein the structure of said caging means is a bird cage having a grating of essentially parallel longitudinal bars, each of length L_{BC}, diameter D_{BC} and spaced at a pitch of P_{BC} with P_{BC}>D_{BC}, interconnecting said power transducing device to said at least one ultrasound reflector element.

24. The ultrasound catheter device of claim 23 wherein both of said diameter D_{BC} and said pitch P_{BC} are made sufficiently large to facilitate an efficient reflection of said ultrasonic power emission thereby further strengthen said acoustic resonance.

25. The ultrasound catheter device of claim 24 wherein said P_{BC} is made considerably smaller than the wavelength of said ultrasonic power emission and said D_{BC} is made not much smaller than said P_{BC} thereby further increase the reflection coefficient of oblique propagating ultrasound waves thus strengthening their acoustic resonance.

26. The ultrasound catheter device of claim 25 wherein said L_{BC} is in the range of from about 5 mm (millimeter) to about 50 mm.

27. The ultrasound catheter device of claim 25 wherein said P_{BC} is in the range of from about 200 μm (micron, 10⁻⁶ meter) to about 2000 μm.

28. The ultrasound catheter device of claim 27 wherein said D_{BC} is in the range of from about 50 μm to about 500 μm.

29. The ultrasound catheter device of claim 23 wherein the exterior of said bird cage is streamline shaped to minimize an associated viscous drag on the natural blood flow within the blood vessel under treatment and to encourage the formation of a blood convective cell pattern internal to the bird cage.

30. The ultrasound catheter device of claim 23 wherein said bird cage further comprises a sound reflecting protective shield, in the form of a substantially cylindrical shell of length L_{PS} and mounted around the waist of said longitudinal bars with L_{PS}<L_{BC}, to further strengthen said acoustic resonance.

31. The ultrasound catheter device of claim 30 wherein both said length L_{BC} and said length L_{PS} are dimensioned such that acoustic jet streams formed from the collapse of cavitations generated near the center of said bird cage will glance a blood vessel wall that is substantially parallel to said longitudinal bars thereby:
differentially ablate the inelastic atheroma while leaving the elastic healthy intima lining intact; and
simultaneously reduce an otherwise associated risk of damaging the healthy intima lining from nearly normal-incident acoustic jet streams.

32. The ultrasound catheter device of claim 31 wherein said L_{PS} is in the range of from about 1 mm to about 10 mm.

33. The ultrasound catheter device of claim 31 wherein said leaky acoustic cavity further comprises a microbubble releasing means, collocated with said bird cage, to release ultrasound contrast microbubbles into the blood to lower the cavitation threshold and to intensify the formation of cavitations thereby enhances the ablation of atheroma.

34. The ultrasound catheter device of claim 33 wherein said ultrasound contrast microbubbles are injected substantially from the interior surface of said protective shield and directed toward the center of said bird cage thus creating the desired cavitations and acoustic jet streams substantially behind said protective shield away from a nearby intima lining to avoid an otherwise risk of puncturing the healthy elastic tissues of the intima lining.

35. The ultrasound catheter device of claim 33 wherein said microbubble releasing means further comprises a drug injecting means for injecting desired drugs into the blood during operation of the ultrasound catheter device.

36. The ultrasound catheter device of claim 35 wherein said desired drugs are anticoagulant drugs or saline.

37. The ultrasound catheter device of claim 14 further comprises a microbubble releasing means, disposed distal to and connected to said ultrasound ablation manifold, to release ultrasound contrast microbubbles into the blood to lower the cavitation threshold and to intensify the formation of cavitations thereby, in combination with an evanescent ultrasonic power emission from said ultrasound ablation manifold, generate cavitations in the blood vessel lumen to further pulverize and emulsify debris fragments that had either not entered the ultrasound ablation manifold or had escaped there from.

38. The ultrasound catheter device of claim 31 wherein said leaky acoustic cavity further comprises a trapping and emulsification means, disposed within and around said ultrasound ablation manifold, to trap larger sized plagues and calcified tissue fragments, created by both extra-cavity ablation and intra-cavity ablation, for prolonging time-integrated emulsification and reabsorption into the body thereafter without clogging up the downstream capillaries.

39. The ultrasound catheter device of claim 38 wherein said trapping and emulsification means further comprises a trapping manifold located interior to said bird cage and having a multitude of well-placed physical barriers adapted to occlude or impede the movement of said larger sized plagues and calcified tissue fragments.

40. The ultrasound catheter device of claim 39 wherein said multitude of physical barriers further comprises a plurality of circular or rectangular grid of thin wires, supported by said bird cage, whose wire diameter is made small enough to not impede the propagation of said ultrasonic power emission.

41. The ultrasound catheter device of claim 38 wherein said trapping and emulsification means is the combination of said bird cage and said protective shield thereby makes the combination multi-functional.

42. The ultrasound catheter device of claim 41 wherein said trapping and emulsification means further comprises a fluid pumping device located inside said ultrasound ablation manifold for creating a local blood vortex sucking the larger sized plagues and calcified tissue fragments into the trapping and emulsification means thereby increases its effectiveness.

43. The ultrasound catheter device of claim 42 wherein said fluid pumping device is a piezoelectric copolymer pump or an electroosmosis pump.

44. The ultrasound catheter device of claim 31 wherein said leaky acoustic cavity further comprises a local blood circulation means, disposed around said ultrasound ablation manifold, to stimulate both an intra-cavity circulation and an extra-cavity circulation of the blood thereby:
a) further prolongs the time-integrated emulsification of said larger sized plagues and calcified tissue fragments; and
b) significantly reduces the viscous resistance to the natural blood flow from the obstructive presence of said ultrasound ablation manifold.

45. The ultrasound catheter device of claim 38 further comprises a positioning means, affixed to said ultrasound ablation manifold, for controllably positioning said ultrasound ablation manifold in close proximity to any diseased blood lumen wall thereby:
a) further increases the ablation efficacy; and
b) allows said trapping and emulsification means to more effectively trap the larger sized plagues and calcified tissue fragments
while avoiding unacceptable occlusion of natural blood circulation through the blood vessel under treatment.

46. The ultrasound catheter device of claim 45 further comprises a positioning control means, disposed near and functionally connected to the proximal end of said catheter tube, for effecting a user interface to said positioning means.

47. The ultrasound catheter device of claim 14 wherein said one or more frequencies are further arranged into a time-varying frequency sweeping over a pre-determined range that contains one or more resonant frequencies of said ultrasound ablation manifold thereby increases the intensity of the ablation process.

48. The ultrasound catheter device of claim 47 wherein said pre-determined frequency range is between 200 KHz and 20 MHz.

49. The ultrasound catheter device of claim 48 wherein said pre-determined frequency range is between 500 KHz and 5 MHz.

50. The ultrasound catheter device of claim 47 wherein said time-varying frequency sweeping is performed pseudo-randomly with a repetition rate higher than 1 Hz.

51. A method for ablating undesirable deposits along the inner blood vessel wall of human and animals, the method comprising:
a) delivering and forcefully injecting, through a point of injection, a pressurized source blood into a blood vessel under treatment to ablate undesirable deposits there from and, after ablating the undesirable deposits, recirculating the injected blood; and
b) extracting and pressurizing the recirculated injected blood for redelivery and forceful reinjection.

52. The method of claim 51 wherein recirculating the injected blood further comprises deflecting the injected source blood downstream of its point of injection and returning part of the deflected blood for recirculation.

53. The method of claim 52 wherein deflecting and returning the injected source blood further comprises providing, via a bipolar mode, an electrical discharge near the point of injection to neutralize with higher efficiency, compared to via an otherwise unipolar discharge mode, excess opposite-sign charges generated from the tearing of healthy or diseased tissues during the ablating process.

54. The method of claim 51 wherein injecting the pressurized source blood further comprises introducing an ultrasonic power emission of high frequency into the blood to remove the undesirable deposits inside said blood vessel under treatment via pulverization and emulsification.

55. The method of claim 51 wherein extracting and pressurizing the recirculated injected blood further comprises filtering the extracted recirculated blood for ridding it of ablated plaques and calcification debris before pressurization for redelivery and reinjection.

56. The method of claim 54 wherein introducing the ultrasonic power emission further comprises forming, together with said point of injection, an ultrasonic acoustic cavity to reflect and confine said ultrasonic power emission therein thereby correspondingly increases the confined ultrasound energy density and the ablating power while limiting a potentially negative biological effect of the high power ultrasonic emission on otherwise healthy tissues located away from the diseased region under treatment.

57. A method of intravascularly ablating atheroma, the method comprises:
piercing a blood vessel under treatment, reaching an atheromatous area therein and ultrasonically pulverize, emulsify hence ablating atheroma from said atheromatous area, with ultrasonically generated cavitations and concomitant high-speed acoustic jet streams in the blood, by:
introducing an ultrasonic power emission of one or more frequencies into the blood; and
providing a leaky acoustic cavity for containing a first portion of said ultrasonic power emission thereby effects an intra-cavity ablation of atheromatous fragments therein while allowing a second portion of said ultrasonic power emission to leak outside said leaky acoustic cavity thereby effects an extra-cavity ablation of atheroma along the blood vessel under treatment.

58. The method of claim 57 wherein providing a leaky acoustic cavity further comprises providing a leaky resonant cavity under at least one operating frequency of said ultrasonic power emission.

59. The method of claim 58 wherein providing a leaky resonant cavity further comprises providing a leaky confocal resonant cavity.

60. The method of claim 58 wherein providing a leaky resonant cavity further comprises providing a cage, acoustically coupled to said leaky resonant cavity, to form a stronger acoustic resonance there with while:
a) allowing circulation of blood and its laden materials there through; and
b) maintaining the leakage of said ultrasonic power emission outside said leaky resonant cavity.

61. The method of claim 60 wherein providing a cage further comprises making the exterior of the cage streamline shaped to minimize an associated viscous drag on the natural blood flow within the blood vessel under treatment and to encourage the formation of a blood convective cell pattern internal to the cage.

62. The method of claim 60 wherein providing a cage further comprises providing a sound reflecting protective shield, in the form of a substantially cylindrical shell mounted around the waist of the cage, to further strengthen said acoustic resonance.

63. The method of claim 62 wherein providing a sound reflecting protective shield further comprises dimensioning the cage and the protective shield such that acoustic jet streams formed from the collapse of cavitations generated near the center of the cage will glance a blood vessel wall that is substantially parallel to the longitudinal axis of the cage thereby:
differentially ablate the inelastic atheroma while leaving the elastic healthy intima lining intact; and
simultaneously reduce an otherwise associated risk of damaging the healthy intima lining from nearly normal-incident acoustic jet streams.

64. The method of claim 62 wherein providing a sound reflecting protective shield further comprises releasing into the blood, in and around the cage, ultrasound contrast microbubbles to lower the cavitation threshold and to intensify the formation of cavitations thereby enhances the ablation of atheroma.

65. The method of claim 64 wherein releasing ultrasound contrast microbubbles further comprises injecting ultrasound contrast microbubbles substantially from the interior surface of the protective shield and directing the microbubbles toward the center of the cage thus creating the desired cavitations and acoustic jet streams substantially behind the protective shield away from a nearby intima lining thereby avoids an otherwise risk of puncturing the healthy elastic tissues of the intima lining.

66. The method of claim 64 wherein releasing ultrasound contrast microbubbles further comprises injecting desired drugs into the blood during the ablating process.

67. The method of claim 57 further comprises releasing ultrasound contrast microbubbles into the blood, distal to the leaky acoustic cavity, to lower the cavitation threshold and to intensify the formation of cavitations thereby, in combination with an evanescent ultrasonic power emission from the leaky acoustic cavity, generate cavitations in the blood vessel lumen to further pulverize and emulsify debris fragments that had either not entered the leaky acoustic cavity or had escaped there from.

68. The method of claim 62 wherein providing the protective shield further comprises trapping larger sized plagues and calcified tissue fragments, created by both extra-cavity ablation and intra-cavity ablation around and inside the leaky acoustic cavity, to prolong their time-integrated emulsification and reabsorption into the body thereafter without clogging up the downstream capillaries.

69. The method of claim 68 wherein trapping larger sized plagues and calcified tissue fragments further comprises providing a fluid pumping device located inside the leaky acoustic cavity for creating a local blood vortex sucking the larger sized plagues and calcified tissue fragments into the leaky acoustic cavity thereby increases its effectiveness.

70. The method of claim 62 wherein providing the protective shield further comprises locally circulating the blood around the leaky acoustic cavity to stimulate both an intra-cavity circulation and an extra-cavity circulation of the blood thereby:
a) further prolongs the time-integrated emulsification of the larger sized plagues and calcified tissue fragments; and
b) significantly reduces the viscous resistance to the natural blood flow from the obstructive presence of the leaky acoustic cavity.

71. The method of claim 68 wherein trapping larger sized plagues and calcified tissue fragments further comprises controllably positioning the leaky acoustic cavity in close proximity to any diseased blood lumen wall thereby:
a) further increases the ablation efficacy; and
b) allows a more effective trapping of the larger sized plagues and calcified tissue fragments
while avoiding unacceptable occlusion of natural blood circulation through the blood vessel under treatment.

72. The method of claim 71 wherein controllably positioning the leaky acoustic cavity further comprises providing an in vitro user interface to effect the positioning.

73. The method of claim 57 wherein introducing an ultrasonic power emission further comprises dynamically sweeping through the one or more frequencies over a predetermined range that contains one or more resonant frequencies of the leaky acoustic cavity thereby increases the intensity of the ablation process.
